(19) United States
(12) Patent Application Publication
(10) Pub. No.: US 2016/0245339 A1
(43) Pub. Date: Aug. 25, 2016

(54) ROLLER BEARING CAGE, ASSEMBLY AND PRODUCTION METHOD THEREFOR, AND ROLLER BEARING

(71) Applicant: JTEKT CORPORATION, Osaka-shi, Osaka (JP)

(72) Inventors: Hideki FUJIWARA, Kitakatsuragi-gun (JP); Masaaki OHTSUKI, Kashihara-shi (JP); Shinya MATSUDA, Kashiba-shi (JP); Toshiya KAKIZAKI, Kashiwara-shi (JP)

(73) Assignee: JTEKT CORPORATION, Osaka-shi, Osaka (JP)

(21) Appl. No.: 15/027,352

(22) PCT Filed: Oct. 9, 2014
(86) PCT No.: PCT/JP2014/077032

§ 371 Date: Apr. 5, 2016

(30) Foreign Application Priority Data
Oct. 10, 2013 (JP) 2013-212531
Oct. 10, 2013 (JP) 2013-212535
Oct. 10, 2013 (JP) 2013-212549

(51) Int. Cl. F16C 33/54; F16C 33/52; F16C 33/50; F16C 19/26; F16C 19/36

(52) U.S. Cl. CPC F16C 33/548; F16C 19/26; F16C 19/364; F16C 33/502; F16C 33/526; F16C 2300/14

(57) ABSTRACT

A roller bearing cage according to one aspect of the invention is a cage having a ring shape for retaining an interval along a circumferential direction between a plurality of rolling elements in a roller bearing. The roller bearing cage includes: a plurality of bar-shaped members which are arranged along the circumferential direction and which restrain movement of the rolling elements along the circumferential direction; a plurality of connecting members, each of which connects end portions along a lengthwise direction of the bar-shaped members adjacent to each other along the circumferential direction; and a fixing structure which fixes the bar-shaped member and the connecting member so as to be relatively unrotatably around an axis line along the lengthwise direction of the bar-shaped member.

### TECHNICAL FIELD

One aspect of the present invention relates to a cage suitably applied to a roller bearing used for supporting a main shaft or the like of a wind power generation device, an assembly method therefor, and a roller bearing.

Another aspect of the present invention relates to a cage suitably applied to a tapered roller bearing used for supporting a main shaft or the like of a wind power generation device, a production method therefor, and a tapered roller bearing.

Still another aspect of the present invention relates to a split cage for a roller bearing, and relates to, for example, a split cage used for a large roller bearing rotatably supporting a main shaft of a wind power generation device.

### BACKGROUND ART

As a roller bearing used for supporting a main shaft of a wind power generation device, for example, a tapered roller bearing is used, and a pin-type cage is used as its cage in some cases (see, for example, Patent Document 1). The pin-type cage includes a pair of retaining rings disposed on both sides along an axial direction of a tapered roller, and a plurality of pins disposed at intervals along a circumferential direction and each having both ends connected to the pair of retaining rings. Each of the pins is inserted into a through hole formed on a center axis line of a corresponding tapered roller, so that a plurality of tapered rollers can be retained at intervals along the circumferential direction.

Besides, a roller bearing used for supporting a main shaft of a wind power generation device has a diameter as large as about 1 to 2 meters, and is thus very large and has a large weight. Therefore, a synthetic resin cage that can be reduced in weight has been recently used instead of a pin-type cage. A synthetic resin cage is, however, more difficult to integrally mold as the size is larger, and therefore, a split type cage that is dividedly molded with respect to each section along the circumferential direction is generally used (see, for example, Patent Document 2).

Alternatively, in a wind power generation device of a horizontal axis propeller type, a roller bearing is used for rotatably supporting a main shaft on which a blade is attached.

In recent years, in accordance with increase of the size of a wind power generation device, the diameter of a main shaft becomes larger than several meters in some cases, and a roller bearing is also increased in size for supporting such a large main shaft.

As a cage used for a large roller bearing, a synthetic resin cage is used in some cases. A synthetic resin cage is advantageous, to a metal cage assembled by welding, in that the weight is small and accuracy is easily ensured. It is, however, difficult to integrally mold, by injection molding, a synthetic resin cage having a large diameter.

Therefore, a split cage divided into a plurality of sections along the circumferential direction is used. Such a split cage includes a plurality of cage segments arranged in a ring shape along the circumferential direction.

A typical example of this type of cage segment includes one disclosed in Patent Document 3. The cage segment disclosed in Patent Document 3 is illustrated in FIG. 24.

Referring to FIG. 24, the cage segment 100 of Patent Document 3 is in an arc shape coaxial with an inner ring and outer ring not shown. The cage segment 100 includes first and second rim portions 210 and 220 opposing each other at a prescribed distance to be paired with each other, and a plurality of pillar portions 400 that are laid between the paired first and second rim portions 210 and 220 and together form, along the circumferential direction, pockets 300 therebetween for holding rolling elements not shown.

### RELATED ART DOCUMENTS

### Patent Documents

Patent Document 1: JP-A-2008-256168

Patent Document 2: JP-A-2012-77882

Patent Document 3: JP-A-2007-255626

### SUMMARY OF THE INVENTION

### Problem to be Solved by the Invention

If the above-described pin-type cage is applied to a large tapered roller bearing, its retaining ring is also very large, and hence, it is difficult not only to produce it but also to handle it for storage, transportation and the like.

On the other hand, in applying a synthetic resin split cage, it is not very difficult to produce it and handle it, but there is a slight difficulty in assemblability of a roller bearing such as a tapered roller. For assembling the roller bearing, taper rollers are to be inserted into pockets of the cage while providing the cage on an outer circumferential side of an inner ring, and when the cage is divided, it easily comes off from the outer circumferential side of the inner ring, and at the same time, the tapered rollers easily come off from the inner ring.

Besides, in the case of the cage segment 100 of Patent Literature 3 illustrated in FIG. 24, a plurality of cage segments 100 are not mutually connected in assembling a roller bearing, and therefore, there arises a problem in which the roller bearing is difficult to assemble because the cage segments 100 easily fall off to scatter.

In consideration of the above-described actual situations, an object of one aspect of the present invention is to provide a roller bearing cage whose components are easily produced and handled and whose structure can be simplified as much as possible, an assembly method therefor, and a roller bearing.

An object of another aspect of the present invention is to provide a tapered roller bearing cage whose components are easily produced and handled, and which can be easily mounted on a tapered roller bearing, a production method therefor, and a tapered roller bearing.

An object of still another aspect of the present invention is to provide a split cage for a roller bearing whose segments are difficult to scatter in assembling the roller bearing, and with which the roller bearing can be easily assembled.

### Means for Solving the Problem

A first aspect of the present invention includes a roller bearing cage having a ring shape for retaining an interval along a circumferential direction between a plurality of rolling elements in a roller bearing, the roller bearing cage including: a plurality of bar-shaped members which are arranged along the circumferential direction and which restrain movement of the rolling elements along the circumferential direction; a plurality of connecting members, each of which connects end portions along a lengthwise direction of the bar-shaped members adjacent to each other along the circumferential direction; and a fixing structure which fixes the bar-shaped member and the connecting member so as to be relatively unrotatably around an axis line along the lengthwise direction of the bar-shaped member.

Since the roller bearing cage according to the first aspect of the present invention includes the plural bar-shaped members, the plural connecting members and the fixing structure, even if it is applied to a large roller bearing, respective components can be made small and simple, and it can be easily produced and handled. Besides, since the cage of the first aspect of the present invention is formed in a ring shape by connecting the plural bar-shaped members with the plural connecting members, when it is mounted on a bearing ring of a roller bearing, it is difficult to be detached from the bearing ring, and hence, an operation of assembling the roller bearing can be easily performed. Besides, since the bar-shaped members and the connecting members are fixed by the fixing structure, the cage can be fixed in a prescribed ring-shaped form, the respective connecting members can be prevented from individually swinging, and vibration of the cage otherwise caused by rotation of the bearing ring of the roller bearing can be suppressed.

A second aspect of the present invention includes a roller bearing cage having a ring shape for retaining an interval along a circumferential direction between tapered rollers corresponding to a plurality of rolling elements used in a tapered roller bearing as a roller bearing, the roller bearing cage including: a plurality of bar-shaped members which are arranged along the circumferential direction and which restrain movement of the rolling elements along the circumferential direction; and a plurality of connecting members, each of which connects end portions along a lengthwise direction of the bar-shaped members adjacent to each other along the circumferential direction, wherein the plurality of bar-shaped members are disposed such that axial centers along the lengthwise direction of the plurality of bar-shaped members cross one another at one point on an axial center of the roller bearing, and wherein the connecting members are bent in an arc shape with a radius of curvature about the one point.

Since the roller bearing cage according to the second aspect of the present invention includes the plural bar-shaped members and the plural connecting members, even if it is applied to a large tapered roller bearing, respective components can be made small and simple, and it can be easily produced and handled. Besides, since the cage of the second aspect of the present invention is formed in a ring shape by connecting the plural bar-shaped members with the plural connecting members, when it is mounted on a bearing ring of a tapered roller bearing, it is difficult to be detached from the bearing ring, and hence, an operation of assembling the tapered roller bearing can be easily performed. Besides, each connecting member of the cage is bent in an arc shape having, as the center of curvature, one point on the axial center of the tapered roller bearing where the axial centers along the lengthwise direction of the bar-shaped members cross one another, and therefore, the bar-shaped members can be attached perpendicularly to the connecting members, and the attaching operation can be easily performed.

A third aspect of the present invention includes the roller bearing cage according to the second aspect, wherein the connecting member has a hole, formed in a direction perpendicular to the connecting member, for inserting and attaching the bar-shaped member.

With this configuration, the hole for attaching the bar-shaped member can be easily formed in the connecting member.

A fourth aspect of the present invention includes the roller bearing cage according to the second or third aspect, further including: a fixing structure which fixes the bar-shaped member and the connecting member so as to be relatively unrotatably around an axis line along the lengthwise direction of the bar-shaped member.

In this case, when the bar-shaped members and the connecting members are fixed by the fixing means, the cage can be fixed in a prescribed ring-shaped form, the connecting members can be prevented from individually swinging, and vibration of the cage otherwise caused by rotation of the bearing ring of the tapered roller bearing can be suppressed.

A fifth aspect of the present invention includes the roller bearing cage according to the first or fourth aspect, wherein the fixing structure includes: a male screw portion formed in an end portion of the bar-shaped member; and a female screw member to be screwed on the male screw portion inserted into the hole formed in the connecting member.

In this case, when the female screw portion is screwed on the male screw member, the bar-shaped member and the connecting member can be fixed.

A sixth aspect of the present invention includes the roller bearing cage according to the first, fourth or fifth aspect, wherein the fixing structure includes: an end portion of the bar-shaped member; and a hole formed in the connecting member to which the end portion of the bar-shaped member is press-fitted.

In this case, the bar-shaped members can be fixed on the connecting members without using an additional component.

A seventh aspect of the present invention includes the roller bearing cage according to any one of the first to sixth aspects, wherein a space surrounded by the bar-shaped members adjacent to each other along the circumferential direction and the connecting member connecting the bar-shaped members is formed as a pocket for holding the rolling element.

An eighth aspect of the present invention includes the roller bearing cage according to any one of the first to sixth aspects, wherein the bar-shaped member is inserted into a hole formed on a center axis line of the rolling element.

In either of the seventh and eighth aspects, an interval along the circumferential direction between the plural rolling elements can be suitably retained.

A ninth aspect of the present invention includes a production method for the roller bearing cage according to any one of the second to eighth aspects, the production method including: forming, in the connecting member formed in a plate shape, a hole for inserting and attaching the bar-shaped member in a direction perpendicular to the connecting member; and bending the connecting member after forming the hole.

When this production method is employed, the hole for inserting and attaching the bar-shaped member is formed in the direction perpendicular to the connecting member in a plate shape before bending, and hence, the hole can be easily formed.

A tenth aspect of the present invention includes an assembly method for the roller bearing cage according to the first, fourth, fifth, sixth, seventh or eighth aspect, the assembly method including: connecting the plurality of bar-shaped members and the plurality of connecting members so as to form a ring shape in a state in which at least one end portion of the bar-shaped member and the connecting member are placed so as to be relatively rotatably around the axis line, and disposing the connected bar-shaped members and the connecting members along a bearing ring of the roller bearing; and fixing, by the fixing structure, the bar-shaped members and the connecting members disposed along the bearing ring so as to be relatively unrotatably around the axis line.

When this assembly method is employed, at the stage where the bar-shaped members and the connecting members are connected and disposed along the bearing ring of the roller bearing, the bar-shaped members and the connecting members are in a relatively rotatable state, and hence, the bar-shaped members and the connecting members connected to one another can be comparatively freely moved, and therefore, an operation of connecting the bar-shaped members and the connecting members and an operation of disposing them along the bearing ring can be easily performed. Then, after disposing the bar-shaped members and the connecting members along the bearing ring, the bar-shaped members and the connecting members are fixed relatively unrotatably, and hence, the vibration of the cage otherwise caused by the rotation of the bearing ring can be suppressed.

An eleventh aspect of the present invention includes a roller bearing including: an inner ring; an outer ring disposed on an outside along a radial direction of the inner ring; a plurality of rolling elements arranged along a circumferential direction between the inner ring and the outer ring; and the cage according to any one of the first to eighth aspects, which retains an interval along the circumferential direction between the plurality of rolling elements.

A twelfth aspect of the present invention includes a split cage for a roller bearing, including: a plurality of first segments made of a synthetic resin and a plurality of second segments made of a synthetic resin, the first segments and the second segments being arranged in a ring shape along a circumferential direction, wherein each of the plurality of first segments includes: a rim portion positioned on a first side along an axial direction; a pair of pillar portions which protrude from the rim portion toward a second side along the axial direction opposite to the first side along the axial direction, and which are respectively disposed between rolling elements of the roller bearing; and a pair of engaging portions provided on the second side along the axial direction of the pair of pillar portions, wherein each of the plurality of second segments includes: a first engaged portion to be engaged with the engaging portion provided on the pillar portion disposed on a first side along the circumferential direction of the first segment; and a second engaged portion to be engaged with the engaging portion provided on the pillar portion disposed on a second side along the circumferential direction opposite to the first side along the circumferential direction of another one of the first segments adjacent, on the first side along the circumferential direction, to the first segment, and wherein the pair of engaging portions are engaged with the pair of engaged portions, whereby the plurality of first segments are connected in a ring shape by the plurality of second segments.

In this configuration, the split cage includes the first segments and the second segments, and in assembling the roller bearing, the first segments adjacent to each other along the circumferential direction are connected by the second segment, and therefore, the first segments and the second segments are difficult to scatter, and the roller bearing can be easily assembled.

A thirteenth aspect of the present invention includes the split cage for a roller bearing according to the twelfth aspect of the present invention, wherein each of the plurality of first segments includes a contact portion to be brought into contact with another one of the first segments adjacent along the circumferential direction.

A fourteenth aspect of the present invention includes the split cage for a roller bearing according to the twelfth or thirteenth aspect, wherein each of the plurality of second segments includes a contact portion to be brought into contact with another one of the second segments adjacent along the circumferential direction.

A fifteenth aspect of the present invention includes the split cage for a roller bearing according to any one of the twelfth to fourteenth aspects, wherein a surface of the pillar portion to be in contact with a roller used as the rolling element has a bent surface recessed along the circumferential direction for restraining the roller from moving along a radial direction.

In this configuration, the roller can be restrained from moving along the radial direction.

A sixteenth aspect of the present invention includes the split cage for a roller bearing according to any one of the twelfth to fifteenth aspects, wherein the engaged portion has a recess through which the engaging portion is capable of being inserted from the radial direction and from which the inserted engaging portion is incapable of being pulled out along the axial direction, wherein each of the plurality of second segments has a groove, which is opened on a surface on the first side along the axial direction of the second segment and crosses the engaged portions, and wherein the split cage for a roller bearing further includes a stopper which is inserted in the groove and which prevents the engaging portion engaged with the engaged portion from coming off in the radial direction.

In this configuration, the engaging portion engaged with the engaged portion can be prevented from coming off in the radial direction.

A seventeenth aspect of the present invention includes the split cage for a roller bearing according to any one of the twelfth to sixteenth aspects, wherein each of the engaged portions has a recess through which the engaging portion is capable of being inserted from outside along the radial direction and from which the inserted engaging portion is incapable of being pulled out in the axial direction, and wherein the split cage for a roller bearing further includes a projection which is formed in an outer side along the radial direction of each of the plurality of second segments which prevents the engaging portion engaged with the engaged portion from coming off outward in the radial direction.

In this configuration, the engaging portion engaged with the engaged portion can be prevented from coming off outward in the radial direction.

### Advantages of the Invention

According to one aspect of the present invention, a roller bearing cage can be easily produced and handled and its structure can be simplified as much as possible.

According to another aspect of the present invention, components of a tapered roller bearing cage can be easily produced and handled, and the cage can be easily mounted on a tapered roller bearing.

According to still another aspect of the present invention, a split cage for a roller bearing whose first segments and second segments are difficult to scatter in assembling the roller bearing, and with which the roller bearing can be easily assembled can be provided.

### BRIEF DESCRIPTION OF THE DRAWINGS

FIG. 1 is a vertical cross-sectional view of a part of a roller bearing according to a first embodiment of the present invention.

FIG. 2 is a lateral cross-sectional view of the roller bearing.

FIG. 3 is an explanatory diagram illustrating the relationship between a rolling element and a cage of the roller bearing.

FIGS. 4(a) to 4(c) are diagrams of components of the cage.

FIGS. 5(a) and 5(b) are diagrams illustrating the components during the production (assembly) of the cage.

FIG. 6 is a vertical cross-sectional view of a part of a roller bearing according to a second embodiment of the present invention.

FIG. 7 is a front view of a part of the roller bearing.

FIG. 8 is an explanatory diagram illustrating the relationship between a rolling element and a cage of the roller bearing.

FIGS. 9(a) and 9(b) are vertical cross-sectional view of a roller bearing according to a third embodiment of the present invention.

FIG. 10 is a cross-sectional view of a principal part of a roller bearing according to a fourth embodiment of the present invention.

FIG. 11 is a schematic front view thereof.

FIG. 12 is a plan view illustrating a part of a split cage for the roller bearing of FIG. 11.

FIG. 13 is an exploded perspective view of FIG. 12.

FIG. 14 is a plan view illustrating a part of a split cage for a roller bearing according to a fifth embodiment of the present invention.

FIG. 15 is an exploded perspective view of FIG. 14.

FIG. 16 is a cross-sectional view of a part for a roller bearing according to a sixth embodiment of the present invention.

FIG. 17 is a plan view illustrating a part of a split cage for a roller bearing according to a seventh embodiment of the present invention.

FIG. 18 is an exploded perspective view of FIG. 17.

FIG. 19 is a perspective view illustrating a part of a split cage for a roller bearing according to an eighth embodiment of the present invention.

FIG. 20 is a perspective view of a state where a stopper of FIG. 19 is removed.

FIG. 21 is a perspective view of a second segment of FIG. 20.

FIG. 22 is a perspective view illustrating a part of a split cage for a roller bearing according to a ninth embodiment of the present invention.

FIG. 23 is a perspective view of a second segment of FIG. 22.

FIG. 24 is a perspective view of a cage segment according to the background art of the present invention.

### MODE FOR CARRYING OUT THE INVENTION

Preferred embodiments of the present invention will now be described with reference to the accompanying drawings.

### First Embodiment

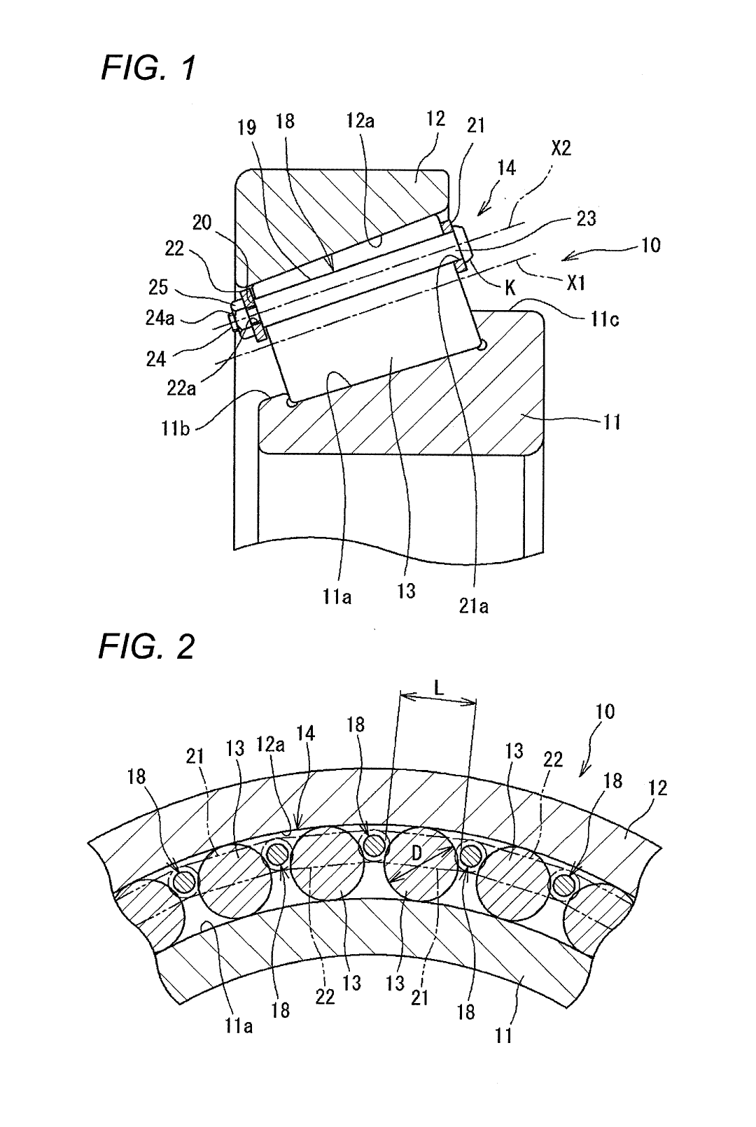

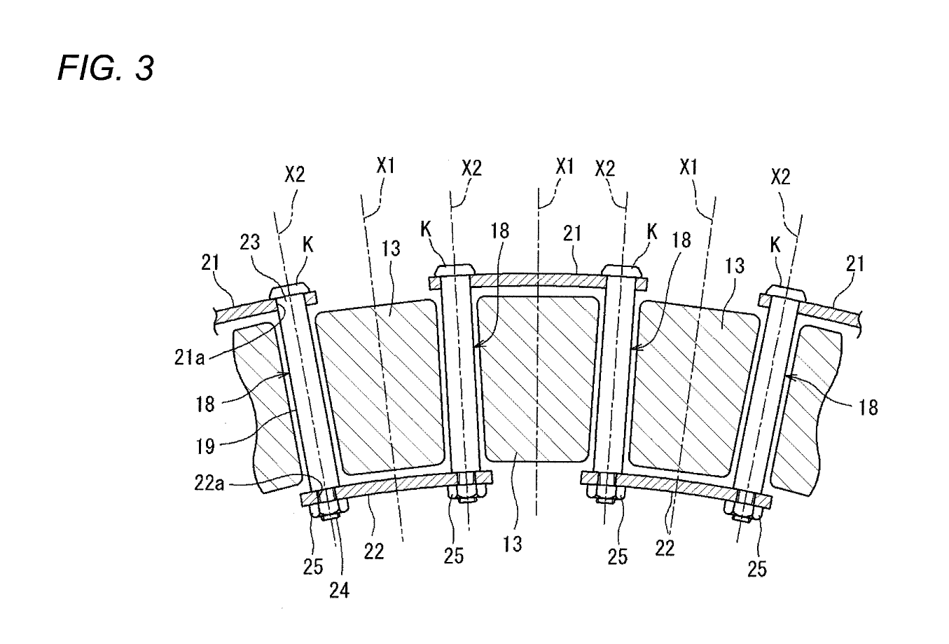

FIG. 1 is a vertical cross-sectional view of a part of a roller bearing according to a first embodiment of the present invention, FIG. 2 is a lateral cross-sectional view of a part of the roller bearing, and FIG. 3 is an explanatory diagram illustrating the relationship between a rolling element and a cage of the roller bearing. It is noted that a tapered roller bearing will be described in the present embodiment as an example of the roller bearing. In the tapered roller bearing, a tapered roller is used as a rolling element.

The roller bearing 10 of the present embodiment is used, for example, for supporting a main shaft of a wind power generation device, and includes a ring-shaped inner ring 11, a ring-shaped outer ring 12 disposed on the outside along a radial direction of the inner ring 11, a plurality of rolling elements (tapered rollers) 13 disposed along a circumferential direction between the inner ring 11 and the outer ring 12, and a cage 14 for retaining a circumferential distance between the plural rolling elements 13.

The inner ring 11 includes an inner ring raceway 11a formed in a conical shape, and a small flange 11b and a large flange 11c formed on both sides along an axial direction of the inner ring raceway 11a and protruding outward along the radial direction. The outer ring 12 includes an outer ring raceway 12a formed in a conical shape. Each rolling element 13 is a tapered roller formed in a shape of a frustum cone (a frustum of a cone), and is capable of moving by rolling on the inner ring raceway 11a and the outer ring raceway 12a. The rolling element 13 is restrained in movement along the axial direction by the small flange 11b and the large flange 11c. Besides, as illustrated in FIG. 3, the respective rolling elements 13 are disposed so that their center axis lines X1 can cross one another at one point on an axial center of the roller bearing 10.

The cage 14 includes a plurality of pins (bar-shaped members) 18 arranged along the circumferential direction, a plurality of connecting links (connecting members) 21 and 22 each connecting the pins 18 adjacent to each other in the circumferential direction, and nuts 25 fixing the pins 18 and the connecting links 22 to each other, and is formed in a ring shape as a whole. Besides, a space surrounded by the pins 18 adjacent to each other in the circumferential direction and the connecting links 21 and 22 connecting these pins 18 is formed as a pocket for holding each rolling element 13.

Each pin 18 includes a trunk 19 formed in an elongated rod shape, and attaching portions 23 and 24 provided in both end portions along a lengthwise direction of the trunk 19. The trunk 19 is formed in a cylindrical shape, and is provided between the rolling elements 13 adjacent to each other in the circumferential direction so as to restrain the movement of the rolling elements 13 along the circumferential direction. The attaching portions 23 and 24 are provided as portions to be attached to the first and second connecting links 21 and 22. Besides, the respective pins 19 are disposed so that their center lines (axis lines) X2 can cross one another at one point on the axial center of the roller bearing 10.

The respective pins 18 are disposed, as illustrated in FIG. 1, on the outside, along the radial direction of the roller bearing 10, of the center axis lines X1 of the rolling elements 13 disposed between the inner ring 11 and the outer ring 12. Besides, as illustrated in FIG. 2, a distance L between the trunks 19 of the pins 18 adjacent to each other in the circumferential direction is substantially the same as or slightly smaller than a diameter D of the rolling element 13 disposed therebetween, and is a size capable of forming a small gap from the rolling element 13.

As illustrated in FIG. 3, the connecting links 21 and 22 include first connecting links 21 connecting first end portions along a lengthwise direction of the pins 18 to each other, and second connecting links 22 connecting second end portions along the lengthwise direction of the pins 18 to each other. The first connecting links 21 and the second connecting links 22 are alternately disposed along the circumferential direction. Accordingly, the first connecting link 21 is attached to the first end portion of each pin 18, and the second connecting link 22 is attached to the second end portion thereof.

Each of the first connecting links 21 and the second connecting links 22 is made of a substantially elliptical plate material, and the end portions (attaching portions) 23 and 24 of the pin 18 are respectively attached to its end portions along the lengthwise direction. Besides, each of the first and second connecting links 21 and 22 is, as illustrated in FIG. 3, formed to be bent in an arc shape. The center of curvature of each of the first and second connecting links 21 and 22 is set to the one point on the axial center of the roller bearing 10 where the center lines X2 of the respective pins 18 cross one another. Accordingly, the pins 18 and the first and second connecting links 21 and 22 are connected to be mutually perpendicular.

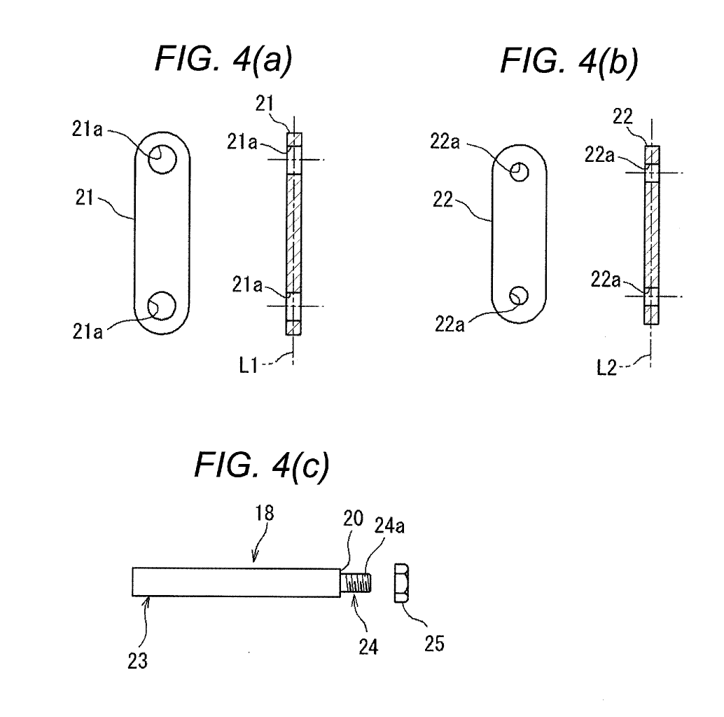

FIGS. 4(a) to 4(c) are diagrams of components of the cage. It is noted that the first and second connecting links 21 and 22 are illustrated, in FIGS. 4(a) to 4(c), in a state before being bent.

FIG. 4(c) illustrates the pin 18 and the nut 25, the first attaching portion 23 of the pin 18 is formed in a cylindrical shape having substantially the same diameter as the trunk 19. The second attaching portion 24 is formed in a cylindrical shape having a smaller diameter than the trunk 19, and a male screw portion 24a to be screwed into the nut 25 is formed on the outer circumferential surface thereof. A step portion 20 is formed on a boundary between the attaching portion 24 and the trunk 19, and the step portion 20 is used for positioning and fixing the second connecting link 22.

FIG. 4(a) illustrates a front view and a cross-sectional view of the first connecting link 21, and FIG. 4(b) illustrates a front view and a cross-sectional view of the second connecting link 22. In both end portions along the lengthwise direction of each of the first connecting link 21 and the second connecting link 22, circular attaching holes 21a or 22a are formed.

Each of the attaching holes (first attaching holes) 21a of the first connecting link 21 has an inner diameter slightly smaller than the outer diameter of the first attaching portion 23 of the pin 18. Besides, as illustrated in FIG. 1, the attaching portion 23 of the pin 18 is press-fitted to the attaching hole 21a in a tight fit state, and thus, the pin 18 is fixed on the first connecting link 21. Furthermore, a part of the attaching portion 23 of the pin 18 protruding beyond the attaching hole 21a is caulked (with a caulked part illustrated with a sign K), so as to prevent the attaching portion from coming off from the attaching hole 21a.

Besides, as illustrated in FIG. 4(b), the attaching hole (second attaching hole) 22a of the second connecting link 22 has an inner diameter rather larger than the outer diameter of the second attaching portion 24 of the pin 18. Besides, as illustrated in FIG. 1, the attaching portion 24 of the pin 18 is inserted into the attaching hole 22a in such a manner that the male screw portion 24a at its tip protrudes beyond the attaching hole 22a. The male screw portion 24a protruding beyond the attaching hole 22a is screwed into the nut 25, and the pin 18 is fixed on the second connecting link 22 because the second connecting link 22 is sandwiched between the nut 25 and the step portion 20 of the pin 18. Incidentally, the configuration in which the attaching portion 23 of the pin 18 is fixed by press-fitting to the attaching hole 21a of the first connecting link 21 and the configuration in which the attaching portion 24 is fixed in the attaching hole 22a of the second connecting link 22 with the nut 25 described above both correspond to a fixing structure for fixing the pin 18 onto the first and second connecting links 21 and 22.

Next, a production (assembly) method for the cage 14 will be described.

As illustrated in FIG. 4(a), the first connecting link 21 has the attaching holes 21a formed in a plate state before being bent in an arc shape. At this point, the attaching holes 21a are formed to penetrate in a direction perpendicular to the first connecting link 21 (for example, in a direction perpendicular to a center line L1 along a thickness direction of the first connecting link 21). Similarly, the second connecting link 22 also has the attaching holes 22a formed in a plate state before being bent in an arc shape as illustrated in FIG. 4(b). The attaching holes 22a are formed to penetrate in a direction perpendicular to the second connecting link 22 (for example, in a direction perpendicular to a center line L2 along a thickness direction of the second connecting link 22).

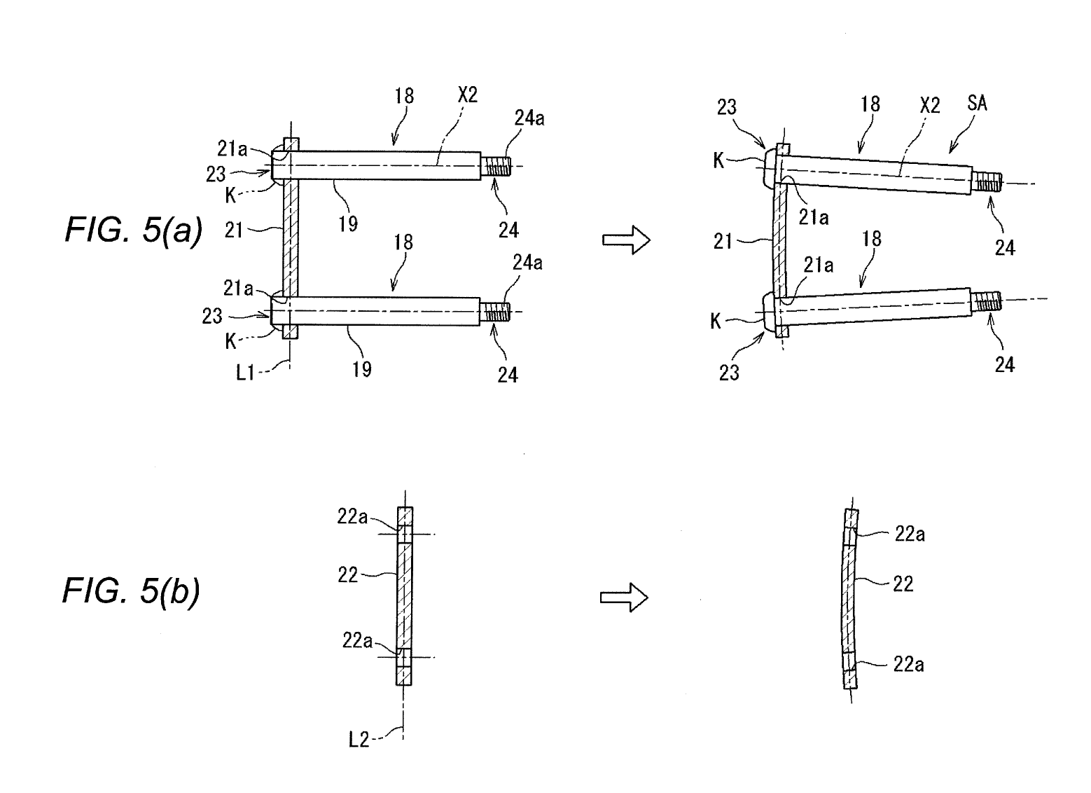

FIGS. 5(a) and 5(b) are diagrams illustrating the components during the production (assembly) of the cage.

The attaching portion 23 of the pin 18 is press-fitted to the attaching hole 21a of the first connecting link 21 before being bent, and caulked (as illustrated on the left side of FIG. 5(a)). Thereafter, the first connecting link 21 is bent so that the center line X2 of the pin 18 can be directed toward a prescribed direction (as illustrated on the right side of FIG. 5(a)). Then, a large number of preliminary assemblies (sub-assemblies) SA each of which includes the first connecting link 21 and the pin 18 in this state are produced.

On the other hand, as illustrated in FIG. 5(b), the second connecting link 22 is bent after forming the attaching holes 22a, and is used as one component.

Then, for assembling the cage 14 to be mounted on the outer circumferential side of the inner ring 11, the second attaching portion 24 of the pin 18 of each preliminary assembly SA is inserted into the attaching hole 22a of a corresponding one of the second connecting links 22 and the nut 25 is loosely screwed on the male screw portion 24a of the second attaching portion 24, so that all the preliminary assemblies SA can be successively connected to the second connecting links 22 in a temporarily connected state, and thus, the cage 14 is formed in a state where it is disconnected in one portion along the circumferential direction (in a belt-like state). Then, while the rolling elements 13 are mounted on the inner ring raceway 11a, the cage 14 in a temporarily connected state is wound around on the outer circumferential side of the inner ring raceway 11a, and thereafter, the cage 14 is connected into a ring shape.

In the cage 14 in a temporarily connected state, the pin 18 and the second connecting link 22 are relatively rotatable around the center line X2 of the pin 18, and hence, the cage 14 can be freely bent, so that an operation of winding it around the outer circumference of the inner ring raceway 11a can be easily performed. Then, after the cage 14 is wound around the outer circumference of the inner ring raceway 11a and connected into a ring shape, all the nuts 25 are rigidly fastened. Thus, the pin 18 and the second connecting link 22 are fixed in a relatively unrotatably state, and the whole cage 14 is fixed in a prescribed ring form. Since the cage 14 is thus fixed in a ring form, the respective connecting links 22 can be prevented from individually swinging in the radial direction when the inner ring 11 or the outer ring 12 of the roller bearing 10 is rotated, and thus, vibration of the cage 14 can be suppressed.

In the present embodiment, since the first and second connecting links 21 and 22 are bent in an arc shape, even if the attaching holes 21a and 22a are formed perpendicularly to the lengthwise direction of the first and second connecting links 21 and 22, the respective pins 18 can be disposed to have their center lines X2 crossing one another at one point on the axial center of the roller bearing 10. In other words, if the first and second connecting links 21 and 22 are in a plate shape, in order to dispose the respective pins 18 to have their center lines X2 crossing one another at one point on the axial center of the roller bearing 10, it is necessary to attach the pins 18 to the first and second connecting links 21 and 22 in an inclined state, which makes it difficult to form the attaching holes 21a and 22a in the first and second connecting links 21 and 22. In the present embodiment, however, the attaching holes 21a and 22a can be formed perpendicularly to the lengthwise direction of the first and second connecting links 21 and 22, and therefore, the attaching holes 21a and 22a can be easily formed.

The respective pins 18 are disposed on the outside, along the radial direction of the roller bearing 10, of the center axis lines X1 of the rolling elements 13, and the distance L between the pins 18 adjacent to each other in the circumferential direction is set to be substantially the same as or smaller than the diameter D of the rolling element 13 disposed therebetween, and therefore, in assembling the roller bearing 10, the rolling elements 13 can be retained in a state where they are fit in the inner ring 11 even without attaching the outer ring 12.

Besides, in the present embodiment, the cage 14 can be formed to have a different outer diameter by controlling the numbers of the pins 18 and the connecting links 21 and 22. Therefore, the pins 18 and the connecting links 21 and 22 can be shared among roller bearings 10 using the same rolling elements 13 but having different outer diameters. Accordingly, the production cost can be reduced.

Furthermore, the cage 14 of the present embodiment is very simply constructed from the pins 18, the connecting links 21 and 22, and the nuts 25, and therefore can be easily and inexpensively produced.

### Second Embodiment

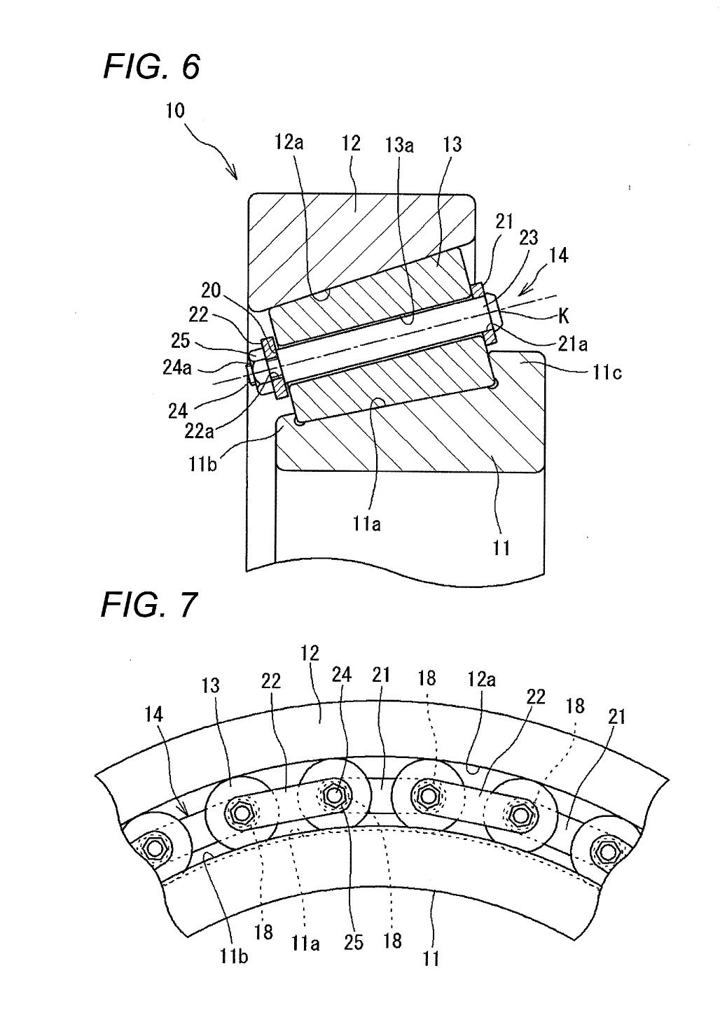

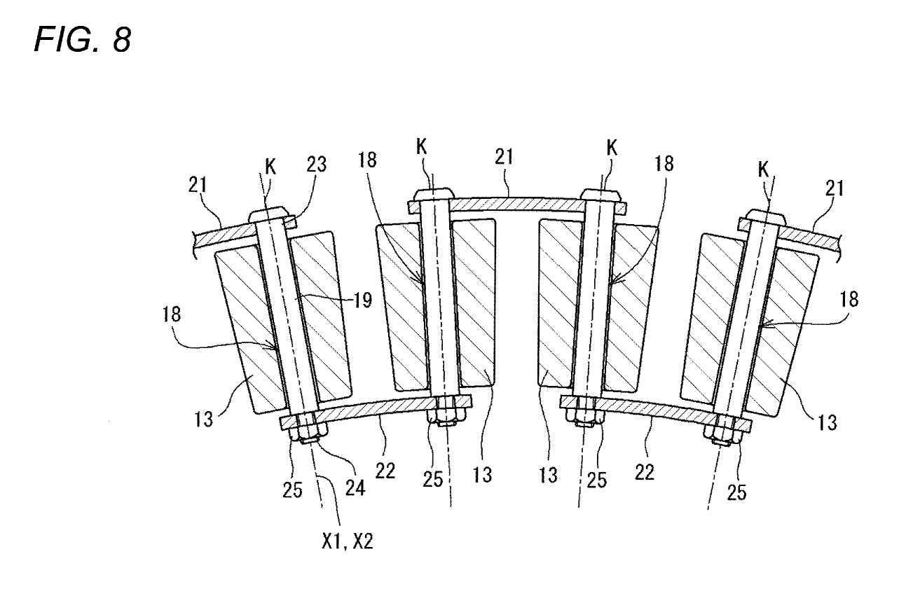

FIG. 6 is a vertical cross-sectional view of a part of a roller bearing according to a second embodiment of the present invention, FIG. 7 is a front view of a part of the roller bearing, and FIG. 8 is an explanatory diagram illustrating the relationship between a rolling element and a cage of the roller bearing.

In the present embodiment, instead of disposing the pin 18 between the rolling elements 13 adjacent to each other along the circumferential direction, the pin 18 is inserted into a through hole 13a formed on the center axis line X1 of the rolling element 13, so as to restrain the movement of the rolling element 13 in the circumferential direction. The rolling element 13 is rotatable around the pin 18. Besides, in the present embodiment, the center axis line X1 of the rolling element 13 accords with the center line X2 of the pin 18.

The first and second connecting links 21 and 22 of the cage 14 are bent in an arc shape as in the first embodiment. Besides, the attaching portion 23 disposed in one end portion of the pin 18 is fixed on the first connecting link 21 by press-fitting, and the attaching portion 24 disposed in the other end portion of the pin 18 is fixed on the second connecting link 22 with the nut 25.

In the present embodiment, in order to mount the cage 14 on the outer circumferential side of the inner ring 11, when the preliminary assemblies SA and the second connecting links 22 are connected in a temporarily connected state as illustrated in FIGS. 5(a) and 5(b), the rolling elements 13 are also attached to the pins 18, the rolling elements 13 are mounted on the inner ring raceway 11atogether with the cage 14 in a temporarily connected state, and then the cage 14 is connected in a ring shape.

### Third Embodiment

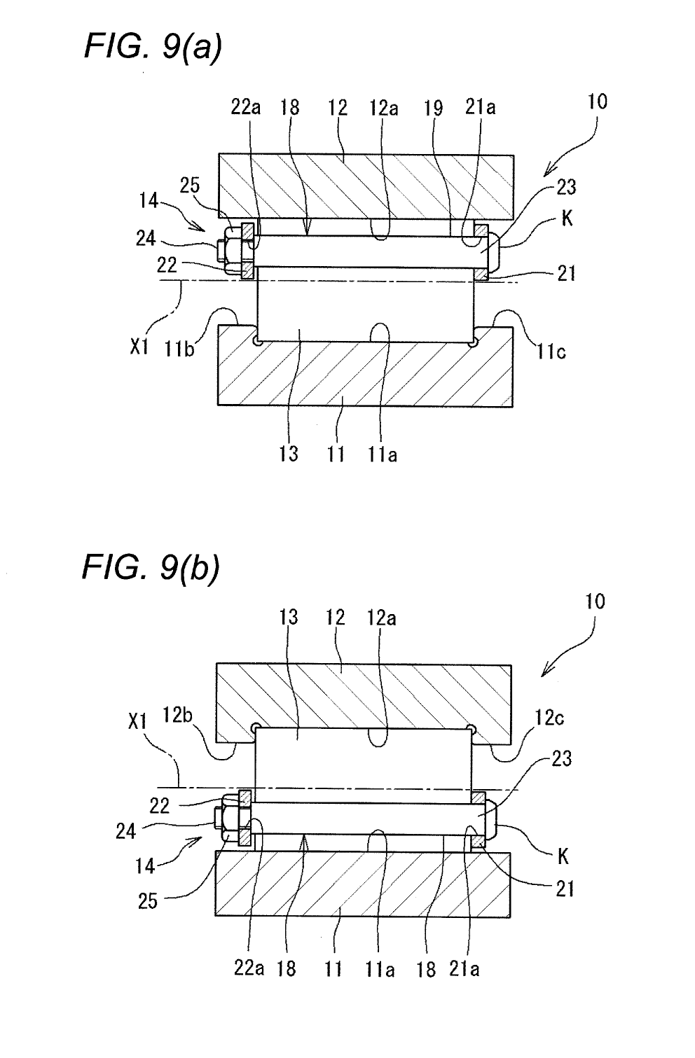

FIGS. 9(a) and 9(b) are vertical cross-sectional view of a part of a roller bearing according to a third embodiment of the present invention.

In the present embodiment, the roller bearing 10 is a cylindrical roller bearing. Pins 18 are disposed between cylindrical rollers 13 adjacent to one another along a circumferential direction. A first connecting link 21 and a second connecting link 21, 22 of a cage 14 are in the same shape excluding the sizes of attaching holes 21a and 22a, and are both in a plate shape not bent in an arc shape. Accordingly, in producing the cage 14, a step of bending the first and second connecting links 21 and 22 is omitted.

Besides, in an example illustrated in FIG. 9(a), flanges 11b and 11c are formed in an inner ring 11, and the pin 18 is disposed on the outside along the radial direction of a center axis line X of the rolling element 13, and in an example illustrated in FIG. 9(b), flanges 12b and 12c are formed in an outer ring 12, and the pin 18 is disposed on the inner side along the radial direction of the center axis line X of the rolling element 13.

Also in the present embodiment, advantageous effects similar to those of the first embodiment described above can be attained.

The present invention is not limited to the first to third embodiments described above, but can be appropriately changed within the scope of the present invention set forth in the appended claims.

For example, in the first to third embodiments described above, the pin 18 of the cage 14 is fixed, at one end portion thereof, on the first connecting link 21 by press-fitting, and fixed, at the other end portion, on the second connecting link 22 with the nut 25, but both the end portions may be fixed with the nut 25, or both the end portions may be fixed by press-fitting. Alternatively, female screws may be formed in the attaching holes 21a and 22a of one or both of the connecting links 21 and 22, with male screws corresponding to the female screws formed in the attaching portions 23 and 24 of the pin 18, so that the pin 18 can be fixed on the connecting links 21 and 22 by screwing the male screws into the female screws. Alternatively, the attaching holes 21a and 22a of one or both of the connecting links 21 and 22 may be formed in a polygonal shape like a rectangular shape, and the attaching holes 21a and 22a of the attaching portions 23 and 24 may be formed in a shape of a polygonal prism corresponding to the polygonal shape of the attaching holes 21a and 22a.

Besides, although the pin 18 is prevented from coming off from the attaching hole 21a by caulking one end thereof in the first to third embodiments described above, it can be prevented from coming off by bonding the pin 18 onto the first connecting link 21 by welding or the like. Alternatively, the pin 18 may be fixed by welding or the like without press-fitting one end thereof to the attaching hole 21a.

Besides, after screwing the nut 25 on the male screw portion 24a of the pin 18, the nut 25 may be bonded onto the second connecting link 22 by welding or the like for preventing the nut 25 from loosening.

Although the processing for bending the second connecting link 22 in an arc shape is performed after attaching the pin 18 on the first connecting link 21 in the first embodiment described above, the processing may be performed before attaching the pin 18.

Although the pin 18 of the cage 14 is disposed between the cylindrical rollers 13 adjacent to each other along the circumferential direction in the third embodiment described above, the pin 18 may be inserted through the center of the cylindrical roller in the same manner as in the second embodiment described above.

In the first to third embodiments described above, the first and second connecting links 21 and 22 are disposed alternately along the circumferential direction, and as a result, a plurality of first connecting links 21 are provided at intervals along the circumferential direction on the side of the first end portions of the pins 18, and a plurality of second connecting links 22 are provided at intervals along the circumferential direction on the side of the second end portions of the pins 18. Instead, on the sides of the first end portions and the second end portions of the pins 18, the first connecting links 21 and the second connecting links 22 may be respectively provided continuously along the circumferential direction. Besides, the trunk 19 of the pin 18 is not limited to the cylindrical shape, but may be formed in a conical shape, a prims shape, a pyramid shape or the like.

### Fourth Embodiment

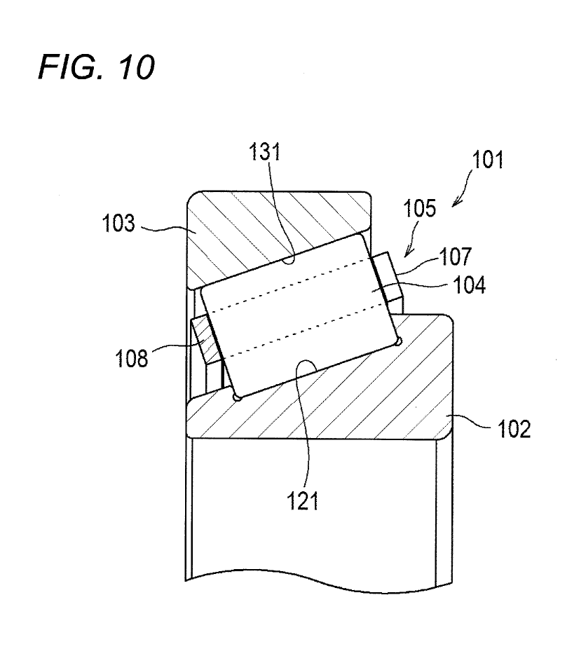

FIG. 10 is a cross-sectional view of a principal part of a roller bearing 101 using a split cage for a roller bearing according to a forth embodiment of the present invention.

Referring to FIG. 10, the roller bearing 101 is a large roller bearing for supporting a main shaft of a wind power generation device. The roller bearing 101 includes an inner ring 102, an outer ring 103, a plurality of rollers 104, and a split cage 105 for retaining these rollers 104.

The inner ring 102 and the outer ring 103 are members both formed in a ring shape by using a steel for a bearing such as a bearing steel or a carburized steel. On an outer circumference of the inner ring 102, an inner ring raceway 121 where the rollers 104 move by rolling is formed along a circumferential direction. On the other hand, the outer ring 103 is coaxial with the inner ring 102, and on an inner circumference thereof, an outer ring raceway 131 where the rollers 104 move by rolling is formed along the circumferential direction to oppose the inner ring raceway 121.

The plural rollers 104 are disposed between the inner ring 102 and the outer ring 103. These rollers 104 are capable of moving by rolling on the inner ring raceway 121 and the outer ring raceway 131, and thus, the inner ring 102 and the outer ring 103 is relatively rotatable.

The split cage 105 retains the rollers 104 between the inner and outer rings 102 and 103. The split cage 105 is formed by using, for example, a synthetic resin, such as a polyether ketone (PEEK) resin reinforced by carbon fiber. The split cage 105 may be formed by using a polyamide resin.

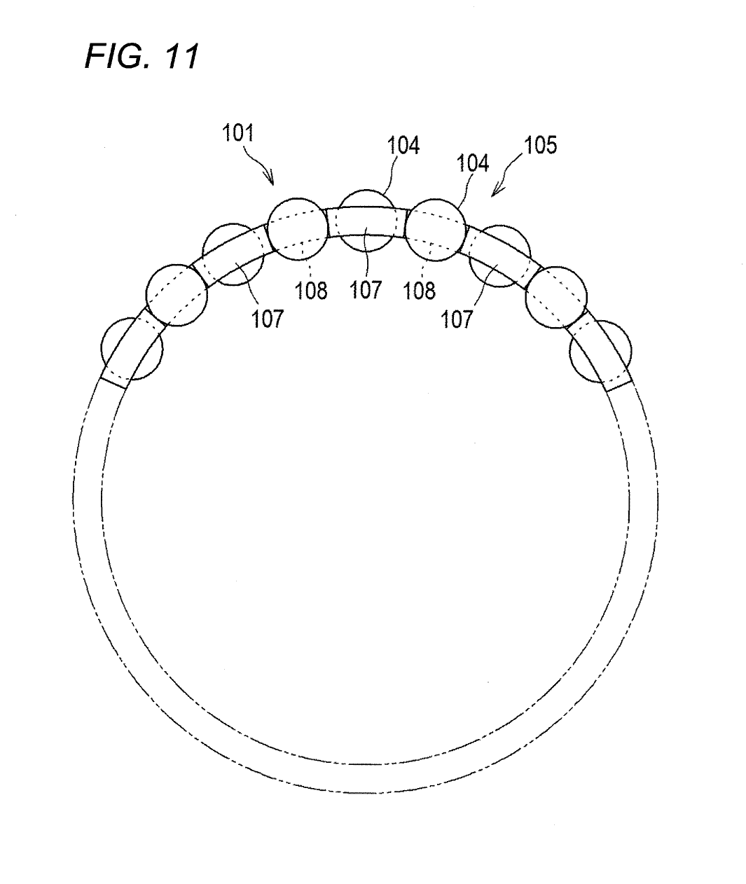

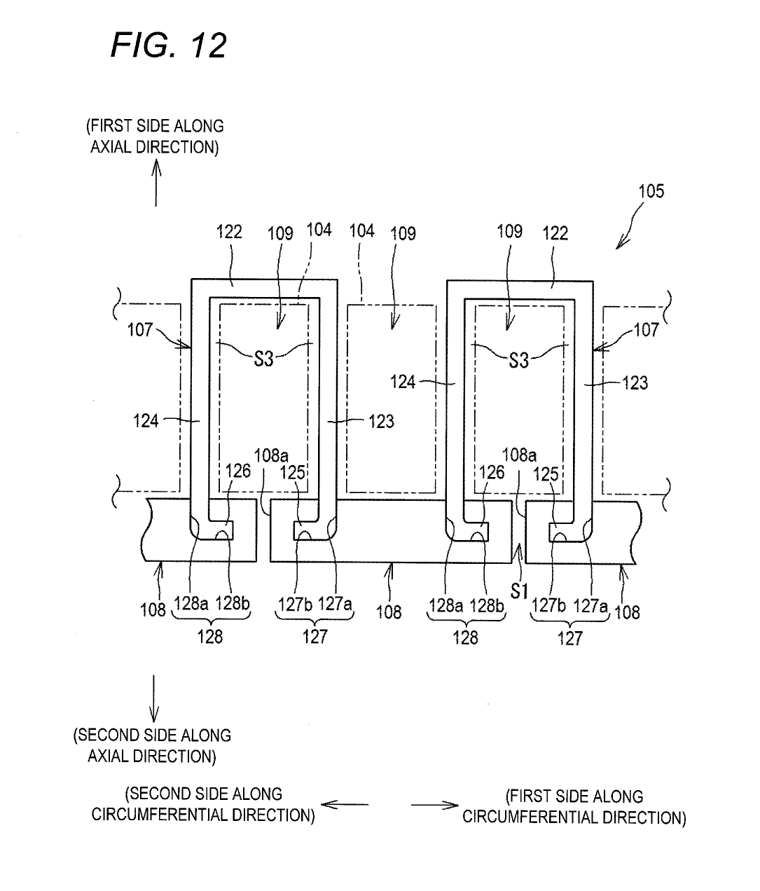

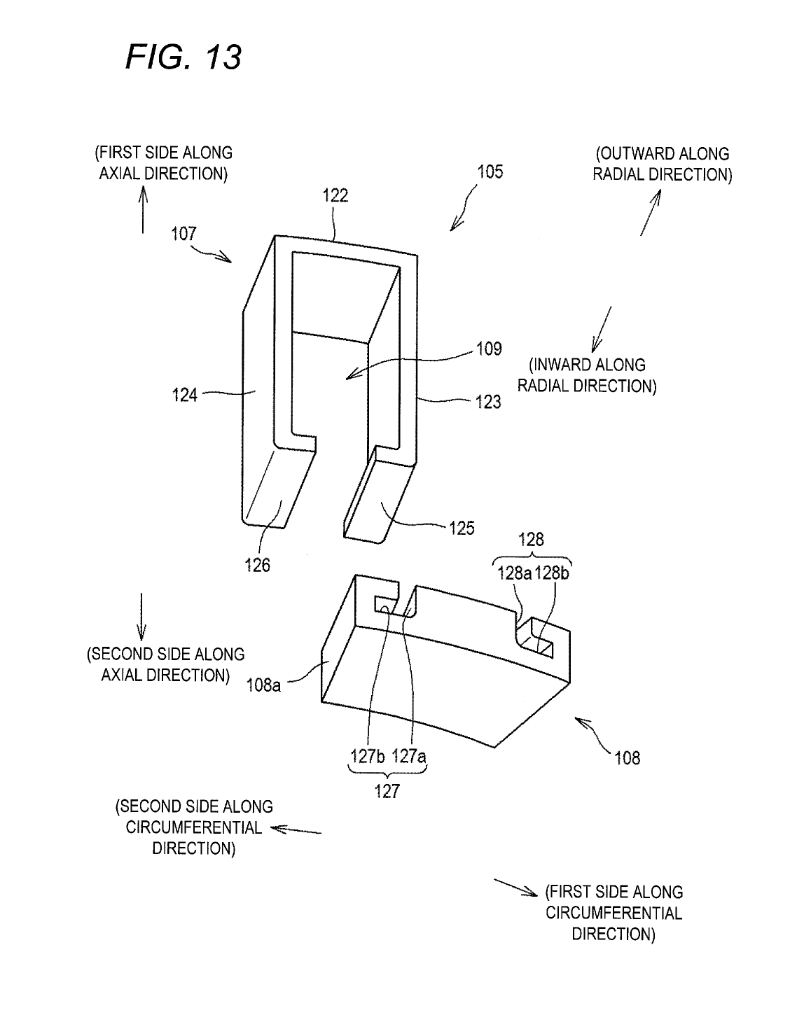

FIG. 11 is a front view schematically illustrating the roller bearing 101, FIG. 12 is a plan view illustrating a part of the split cage 105 for the roller bearing of FIG. 11, and FIG. 13 is an exploded perspective view of FIG. 12. In these drawings, the split cage 105 is provided with pockets 109 for holding the rollers 104 arranged in a ring shape along the circumferential direction, and the split cage 105 includes a plurality of first segments 107 and second segments 108 made of a synthetic resin. The first segments 107 and the second segments 108 are respectively provided in a plural number arranged in a ring shape along the circumferential direction.

A prescribed distance is provided between the first segments 107 adjacent to each other in the circumferential direction, and this distance between the adjacent first segments 107 is used as a pocket 109 for holding the roller 104, and a pocket 109 is also provided inside each first segment 107.

Each first segment 107 is disposed to extend from a first side to a second side along an axial direction of the split cage 105, and includes a rim portion 122, a pair of first and second pillar portions 123 and 124, and a pair of engaging portions 125 and 126. The rim portion 122 is positioned on the first side along the axial direction, and is formed in a plate shape having planes facing both the sides along the axial direction. The first pillar portion 123 is positioned on a first side along the circumferential direction of the first segment 107, the second pillar portion 124 is positioned on a second side along the circumferential direction of the first segment 107, and the pillar portions 123 and 124 extend from end portions along the circumferential direction of the rim portion 122 toward the second side along the axial direction. Each of the pillar portions 123 and 124 is formed in a plate shape having planes facing both the sides along the circumferential direction, and oppose each other along the circumferential direction. A distance between the pillar portions 123 and 124 is set to be the same as the distance between the first segments 107 adjacent to each other along the circumferential direction, and the distance between the pillar portions 123 and 124 is used as the pocket 109 for holding the roller 104. In other words, the pillar portions 123 and 124 are disposed between the rollers 104 of the roller bearing 101. The first and second engaging portions 125 and 126 are provided to protrude inward respectively from end portions on the second side along the axial direction of the first and second pillar portions 123 and 124, and protrude to come close to each other. Incidentally, in the present application, the engaging portions 125 and 126 may include the end portions on the second side along the axial direction of the pillar portions 123 and 124 in some cases.

The second segments 108 are provided on the second side along the axial direction of the split cage 105 for connecting the first segments 107 adjacent to each other along the circumferential direction. Each of the second segments 108 is formed in a block shape, having planes facing both sides along the axial direction, the circumferential direction and a radial direction. An appropriate circumferential gap S1 is formed between the second segments 108 adjacent to each other along the circumferential direction, and the gap S1 is set to be smaller than a sum of two gaps S3 along the circumferential direction between the pillar portions 123 and 124 of the first segment and the roller 104. An end surface disposed on each side along the circumferential direction of the second segment 108 is formed as a contact portion 108a capable of coming into contact with the second segment 108 adjacent along the circumferential direction. Incidentally, instead of providing the gap S1, the second segments 108 adjacent to each other along the circumferential direction may be precedently in contact with each other in some cases. In end portions along the circumferential direction of each second segment 108, a pair of first and second engaged portions 127 and 128 opened toward the first side along the axial direction are formed to penetrate along the radial direction. The first engaged portion 127 is disposed in the end portion on the second side along the circumferential direction of the second segment 108, the second engaged portion 128 is disposed in the end portion on the first side along the circumferential direction of the second segment 108, and these engaged portions 127 and 128 are engaged by inserting the engaging portions 125 and 126 therethrough from the radial direction, so that the engaging portions 125 and 126 cannot come off from the engaged portions 127 and 128 toward the first side along the axial direction. Specifically, each of the engaged portions 127 and 128 is in an L-shape in a plan view, and includes an axial portion 127a or 128a and a circumferential portion 127b or 128b. The axial portion 127a or 128a is formed in a part of the second segment 108 extending from a surface positioned on the first side along the axial direction to a middle portion along the axial direction, so as to be engaged with an end portion on the second side along the axial direction of the pillar portion 123 or 124 of the first segment 107. The peripheral portion 127b or 128b is formed in a part extending from the bottom of the axial portions 127a or 128a outward along the circumferential direction of the second segment 108, so as to be engaged with the engaging portion 125 or 126 of the first segment 107.

In the exemplified structure described above, for assembling the roller bearing 101, the end portion on the second side along the axial direction of the first pillar portion 123 and the first engaging portion 125 provided in this end portion of the first segment 107 are engaged with the first engaged portion 127 of the second segment 108. Besides, the end portion on the second side along the axial direction of the second pillar portion 124 and the second engaging portion 126 provided in this end portion of another first segment 107 adjacent to the former first segment 107 on the first side along the circumferential direction are engaged with the second engaged portion 128 of the second segment 108. This process is repeated along the circumferential direction, and thus, the first segments 107 adjacent to each other along the circumferential direction are connected by using the second segments 108, so as to construct the split cage 105. Besides, in addition, the rollers 104 are respectively mounted into the pockets 109 provided inside the first segments 107 and between the first segments 107 adjacent to each other along the circumferential direction. In this manner, the roller bearing 101 can be assembled. During the assembly, the roller bearing 101 is assembled while alternately connecting the first segments 107 and the second segments 108 forming the split cage 105 as described above, and therefore, the first segments 107 and the second segments 108 are prevented from falling off to scatter during the assembly, and hence the roller bearing 101 can be easily assembled.

Furthermore, in power generation by a wind power generation device, when the inner ring 102 of the roller bearing 101 is rotated against the outer ring 103, the rollers 104 move by rolling on the inner ring 102 and the outer ring 103, and the split cage 105 retaining the rollers 104 is rotated in the same direction as the inner ring 102. At this point, large radial load may be applied between the outer ring 103 and the inner ring 102 in, for example, a given circumferential portion in some cases. In such a case, lead and lag of the rollers 104 is increased toward the portion where the radial load is applied, and therefore, the rollers 104 come into contact with the split cage 105. As a result, tensile load or compressive load is applied to the split cage 105 along the circumferential direction. In such a case, the second segments 108 adjacent to each other along the circumferential direction come close to each other, and their contact portions 108a come into contact with each other, and thus, the rigidity and the strength of the split cage 105 is improved.

### Fifth Embodiment

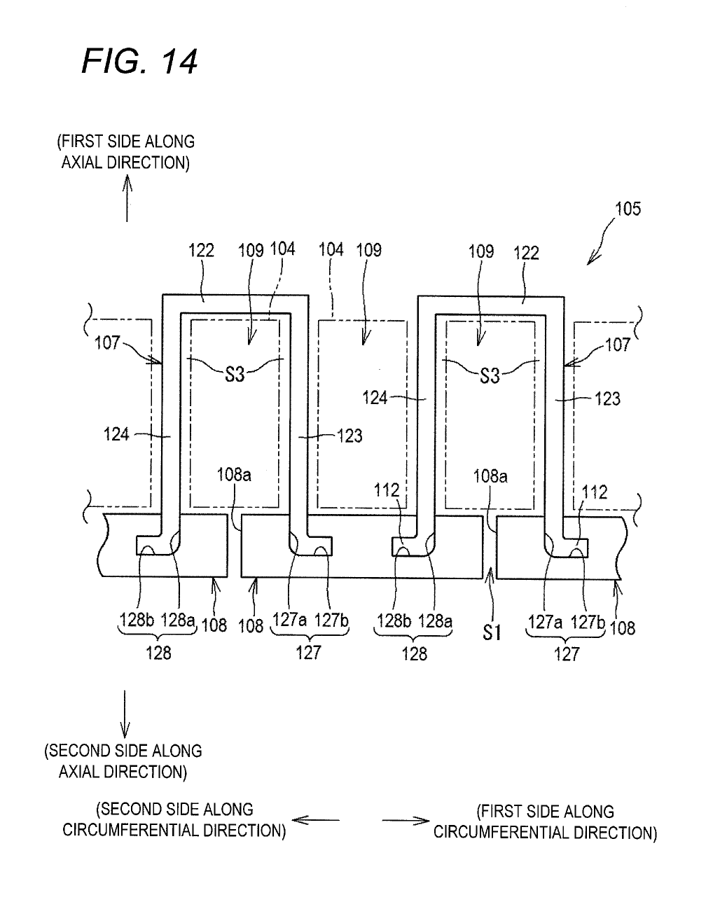

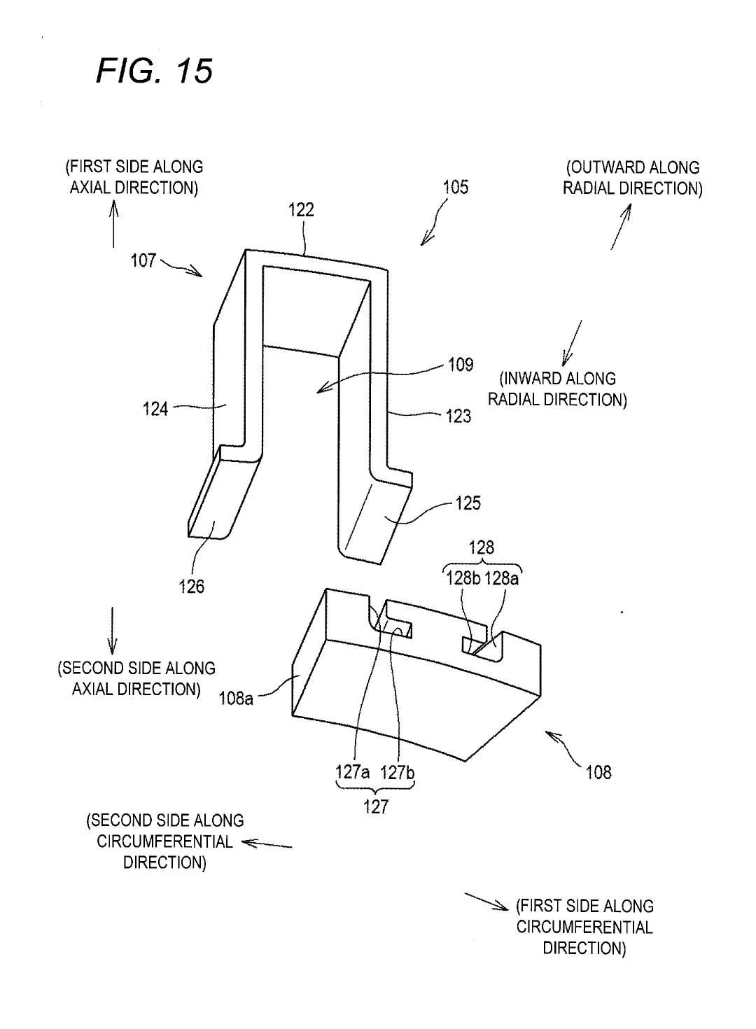

FIGS. 14 and 15 illustrate a fifth embodiment of the present invention, in which the first and second engaging portions 125 and 126 are respectively formed to protrude outward, to be away from each other, from the end portions on the second side along the axial direction of the first and second pillar portions 123 and 124. The engaged portions 127 and 128 of the second segment 108 are formed correspondingly, and the circumferential portions 127b and 128b of the engaged portions 127 and 128 are respectively formed in portions extending from bottoms of the axial portions 127a and 128a inward along the circumferential direction of the second segment 108.

### Sixth Embodiment

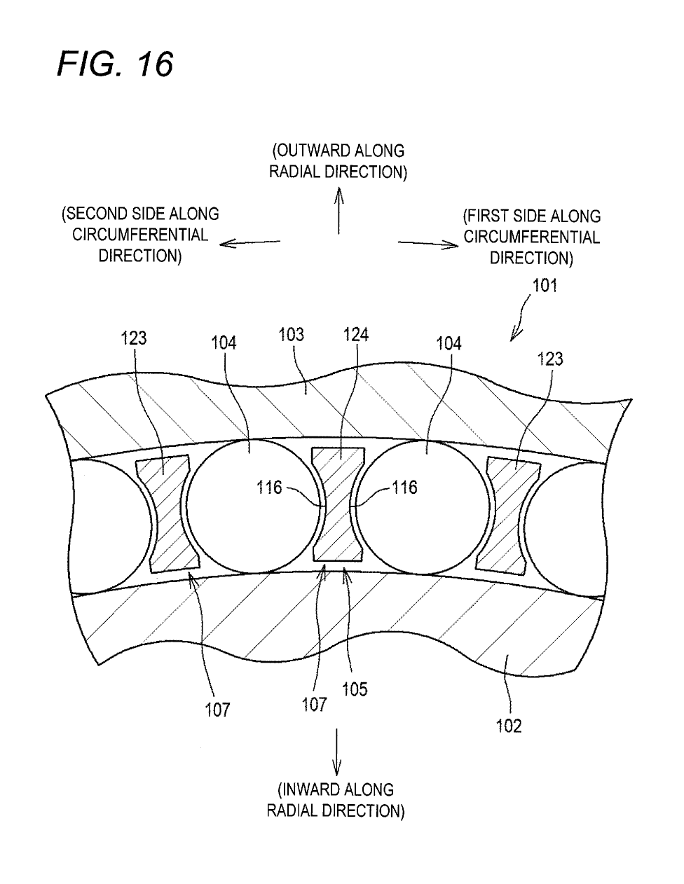

FIG. 16 illustrates a sixth embodiment of the present invention, in which a surface of each pillar portion 123 or 124 of the first segment 107 to be in contact with the roller 104 is formed as a bent surface 116 concaved along the circumferential direction, and thus, the movement of the roller 104 along the radial direction is restrained.

When this structure is employed, the roller 104 is fit between the bent surfaces 116 of the pillar portions 123 and 124 disposed on both sides along the circumferential direction of the roller 104 in the first segment 107, and hence, the movement along the radial direction of the roller 104 can be restrained.

### Seventh Embodiment

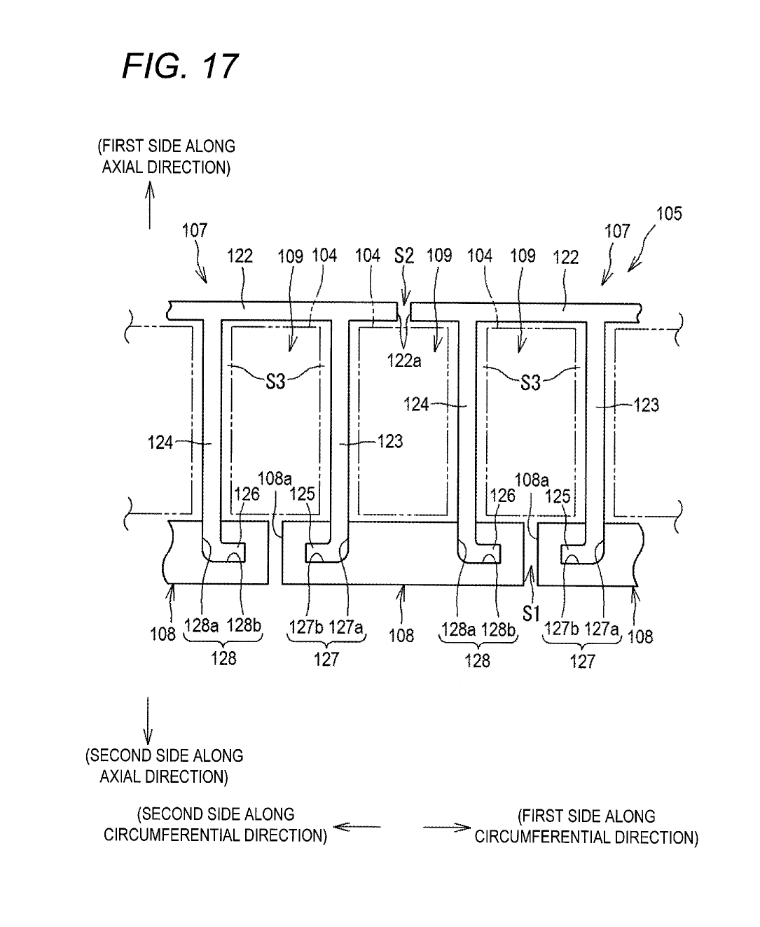

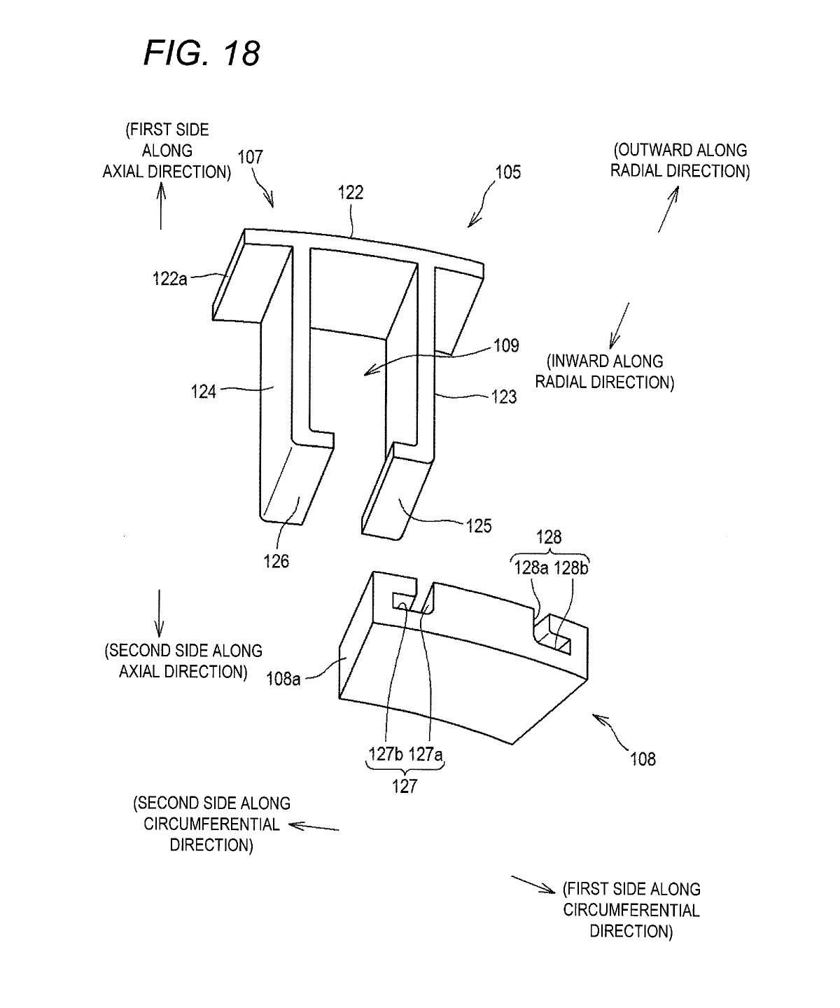

FIGS. 17 and 18 illustrate a seventh embodiment of the present invention, in which both end portions along the circumferential direction of the rim portion 122 of the first segment 107 are formed to protrude respectively beyond the pillar portions 123 and 124 in the circumferential direction, and an appropriate circumferential gap S2 is formed between the rim portions 122 of the first segments 107 adjacent to each other in the circumferential direction. This gap S2 is set to be smaller than a sum of two gaps S3 along the circumferential direction between the pillar portions 123 and 124 of the first segment and the roller 104. The gap S2 is generally set to be the same as the gap 51 between the second segments 108 adjacent to each other along the circumferential direction, but may not be the same in some cases. Each end surface along the circumferential direction of the rim portion 122 is formed as a contact portion 122a to be in contact with each end surface along the circumferential direction of the rim portion 122 of the first segment adjacent along the circumferential direction. Incidentally, in some cases, the rim portions 122 of the first segments 107 adjacent to each other in the circumferential direction may be brought into contact with each other without providing the gap S2.

In this example, in power generation by a wind power generation device, if lead and lag of the rollers 104 occurs, not only the second segments 108 adjacent to each other along the circumferential direction but also the first segments 107 adjacent to each other along the circumferential direction come close to each other, and their rim portions 122 are in contact with each other, and thus, the rigidity and the strength of the split cage 105 are improved.

Besides, in some cases, when the roller 104 moves by rolling, a part of the roller 104 may collide with a corner formed by a portion where the rim portion 122 is connected to the pillar portion 123 or 124. As a result, stress is concentrated on the corner to deform the pillar portion 123 or 124 or the rim portion 122. If the gaps S1 and S2 are provided, however, the adjacent second segments 108 forming the gap S1 or the adjacent rim portions 122 forming the gap S2 can be brought close to or into contact with each other as compared with before the stress concentration. As a result, the stress can be released.

### Eighth Embodiment

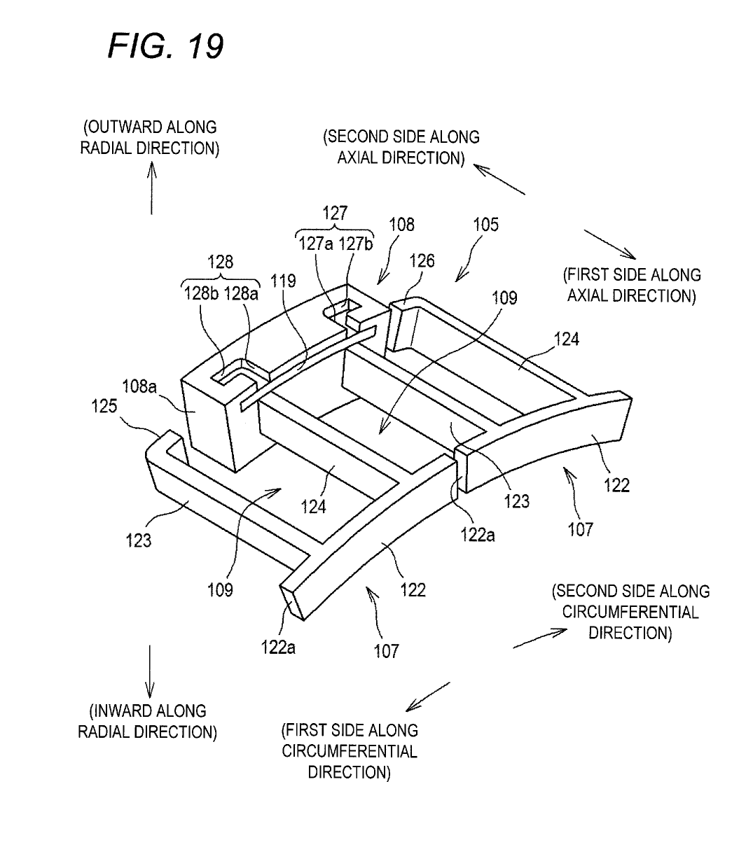

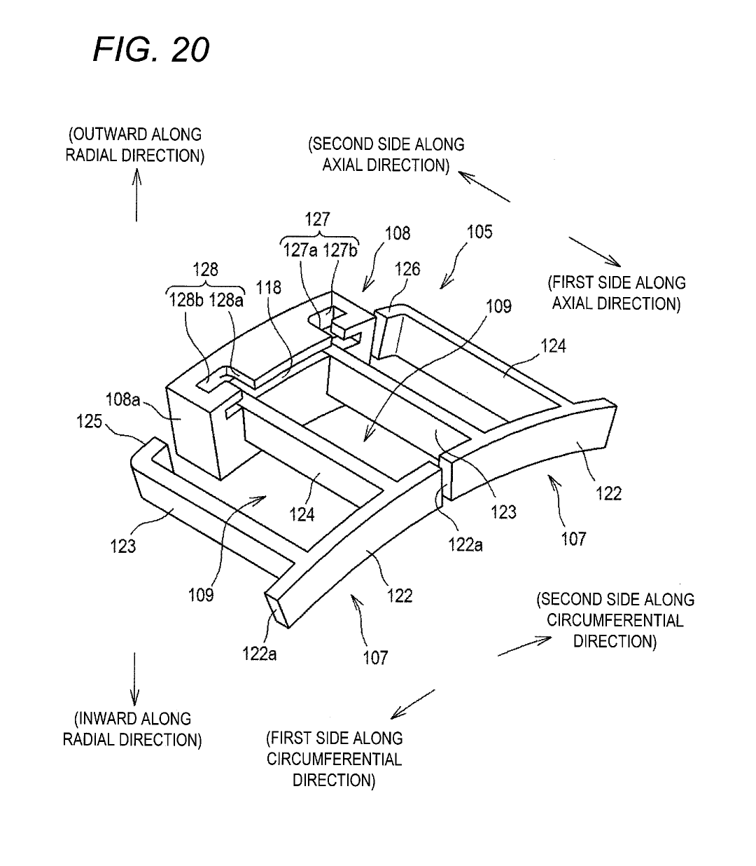

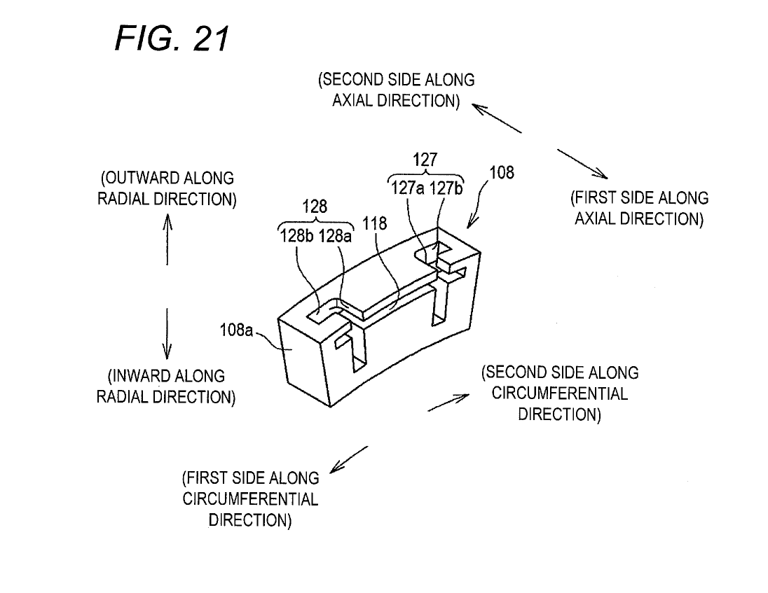

FIGS. 19 to 21 illustrate an eighth embodiment of the present invention, in which the engaged portions 127 and 128 of the second segment 108 are formed as recesses opened merely toward the first side along the axial direction and outward along the radial direction. Owing to the recesses, the engaging portions 125 and 126 can be inserted from the radial direction, and the inserted engaging portions 125 and 126 cannot be pulled out in the axial direction. A groove 118 opened toward the first side along the axial direction is formed on an outer side along the radial direction of the second segment 108. The groove 118 is formed, in the second segment 108, in a circumferential portion crossing over the engaged portions 127 and 128, and cross the engaged portions 127 and 128 to communicate with them, and end portions along the circumferential direction of the groove 118 extend outward along the circumferential direction beyond the axial portions 127a and 128a of the engaged portions 127 and 128. The groove 118 is positioned on the outside, along the radial direction, of the end portions on the second side along the axial direction of the pillar portions 123 and 124 of the first segment 107 engaged with the engaged portions 127 and 128, and of the engaging portions 125 and 126. A stopper 119 of a leaf spring or the like is inserted and attached to the groove 118, and thus, the engaging portions 125 and 126 and the like are prevented from coming off from the engaged portions 127 and 128 outward in the radial direction. Incidentally, the engaged portions 127 and 128 of the second segment 108 may be formed as recesses opened merely toward the first side along the axial direction and inward along the radial direction, and the groove 118 may be formed not on the outer side along the radial direction but on an inner side along the radial direction of the second segment 108, and thus, the engaging portions 125 and 126 and the like may be prevented from coming off from the engaged portions 127 and 128 inward in the radial direction.

In this example, when the stopper 119 is inserted into the groove 118 of the second segment 108 after engaging the engaging portions 125 and 126 and the like of the first segment 107 with the engaged portions 127 and 128 of the second segment 108, the engaging portions 125 and 126 and the like can be prevented from coming off from the engaged portions 127 and 128 outward in the radial direction.

### Ninth Embodiment

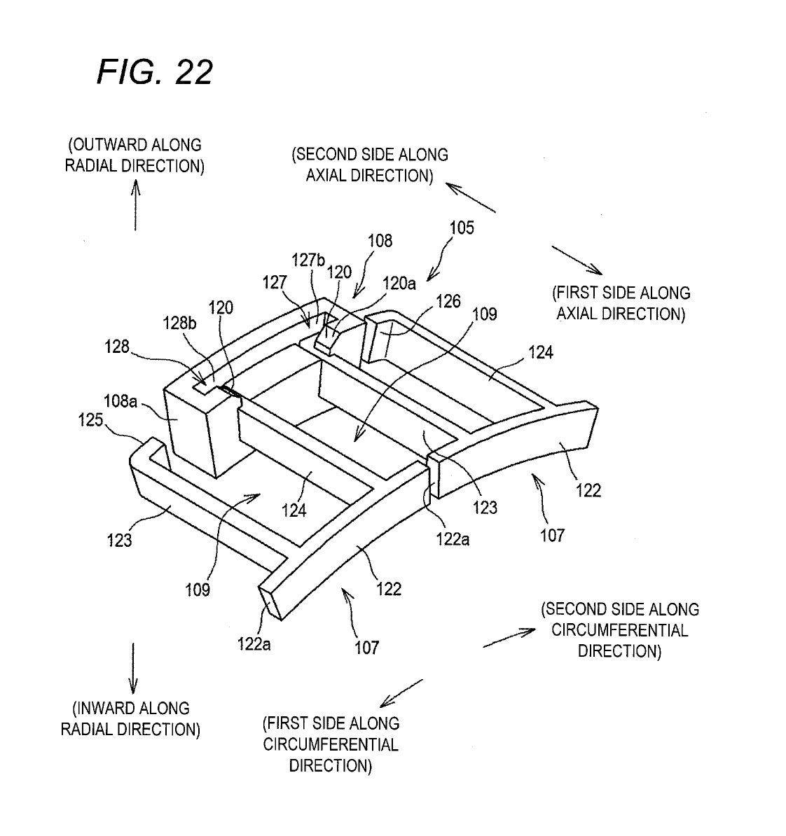

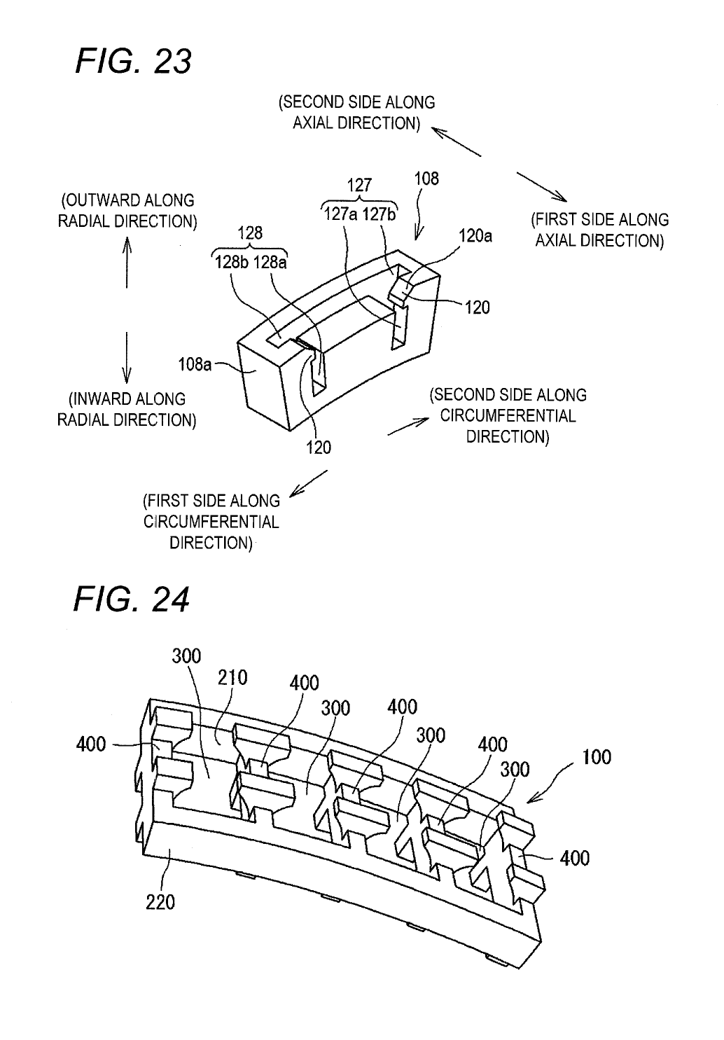

FIGS. 22 and 23 illustrate a ninth embodiment of the present invention, in which the engaged portions 127 and 128 of the second segment 108 are formed as recesses opened merely toward the first side along the axial direction and outward along the radial direction in the same manner as described above. Owing to the recesses, the engaging portions 125 and 126 can be inserted from the radial direction, and the inserted engaging portions 125 and 126 cannot be pulled out in the axial direction. On an inner surface on the outer side along the circumferential direction of the axial portion 127a or 128a of each engaged portion 127 or 128, a projection 120 is integrally formed. The projection 120 is formed on an outside side along the radial direction in the inner surface, and closes about a half area (or an area larger or smaller than the half) of an opening on the outer side along the radial direction of the axial portion 127a or 128a. Besides, the projection 120 is positioned on the outer side along the radial direction of the end portions of the pillar portions 123 and 124 engaged with the engaged portions 127 and 128, and thus, the end portions of the pillar portions 123 and 124 and the engaging portions 125 and 126 are prevented from coming off from the engaged portions 127 and 128 outward in the radial direction. The projection 120 is in a substantially triangle shape when seen from the axial direction, and has, on its surface on the outer side along the radial direction, an inclined surface 120a inclined inward along the radial direction toward the inside of the second segment 108 (the side of the opposing projection 120) along the circumferential direction.

In this example, when the end portions on the second side along the axial direction of the pillar portions 123 and 124 and the engaging portions 125 and 126 of the first segment 107 are to be engaged with the engaged portions 127 and 128, with the end portion of each of the pillar portions 123 and 124 brought into contact with the inclined surface 120a of the projection 120, the projection 120 is pushed inward along the radial direction. Thus, a peripheral portion of the projection 120 of the second segment 108 is elastically deformed to make the projection 120 recede outward along the radial direction, and thus, the end portion of each of the pillar portions 123 and 124 and each of the engaging portions 125 and 126 is allowed to engage with the engaged portion 127 or 128. After the engagement, the projection 120 and its peripheral portion of the second segment 108 are restored to the original positions due to elastic restoring force, and thus, the engaging portions 125 and 126 and the like are prevented from coming off from the engaged portions 127 and 128 outward along the radial direction.

It is noted that the present invention is not limited to the fourth to ninth embodiments described above. For example, each engaged portion may be formed in a dovetail groove shape, with each engaging portion formed in a corresponding shape.

Besides, in the fourth to ninth embodiments described above, the present invention is described by assuming the application to a split cage for a roller bearing. The present invention is, however, not limited to this configuration. The present invention may be applied to, for example, a split cage for a rolling bearing such as a ball bearing or a tapered roller bearing.

Furthermore, in the fourth to ninth embodiments described above, the present invention is described by assuming the application to a cage for a roller bearing for a main shaft for wind power generation having a large outer diameter, but instead of the application to the wind power generation, the present invention may be applied to a cage for another roller bearing such as a roller bearing for a slewing ring shaft.

In addition, it goes without saying that the design can be variously changed or modified within the scope of the appended claims.

In other words, the embodiments disclosed herein are merely exemplary, and the present invention is not limited to the above-described embodiments. The scope of the present invention is defined by the appended claims in consideration of the present disclosure, and includes all modifications made within the scope of the appended claims and their equivalents.

This application is based upon the prior Japanese patent applications (Japanese Patent Application No. 2013-212535, Japanese Patent Application No. 2013-212549 and Japanese Patent Application No. 2013-212531) filed on Oct. 10, 2014, the entire contents of which are incorporated herein by reference.

### DESCRIPTION OF REFERENCE SIGNS

10: roller bearing, 11: inner ring (bearing ring), 12: outer ring (bearing ring), 13: rolling element, 14: cage, 18: pin (bar-shaped member), 21: first connecting link (connecting member), 22: second connecting link (connecting member), 24a: male screw portion, 25: nut (female screw member), 101: roller bearing, 102: inner ring, 103: outer ring, 104: roller, 105: split cage, 107: first segment, 108: second segment, 108a: contact portion, 109: pocket, 116: bent surface, 119: stopper, 120: projection, 122: rim portion, 122a: contact portion, 123: first pillar portion, 124: second pillar portion, 125: first engaging portion, 126: second engaging portion, 127: first engaged portion, 128: second engaged portion

1. A roller bearing cage having a ring shape for retaining an interval along a circumferential direction between a plurality of rolling elements in a roller bearing, said roller bearing cage comprising:
a plurality of bar-shaped members which are arranged along the circumferential direction and which restrain movement of the rolling elements along the circumferential direction;
a plurality of connecting members, each of which connects end portions along a lengthwise direction of the bar-shaped members adjacent to each other along the circumferential direction; and
a fixing structure which fixes the bar-shaped member and the connecting member so as to be relatively unrotatably around an axis line along the lengthwise direction of the bar-shaped member.

2. A roller bearing cage having a ring shape for retaining an interval along a circumferential direction between tapered rollers corresponding to a plurality of rolling elements used in a tapered roller bearing as a roller bearing, said roller bearing cage comprising:
a plurality of bar-shaped members which are arranged along the circumferential direction and which restrain movement of the rolling elements along the circumferential direction; and
a plurality of connecting members, each of which connects end portions along a lengthwise direction of the bar-shaped members adjacent to each other along the circumferential direction,
wherein the plurality of bar-shaped members are disposed such that axial centers along the lengthwise direction of the plurality of bar-shaped members cross one another at one point on an axial center of the roller bearing, and
wherein the connecting members are bent in an arc shape with a radius of curvature about the one point.

3. The roller bearing cage according to claim 2,
wherein the connecting member has a hole, formed in a direction perpendicular to the connecting member, for inserting and attaching the bar-shaped member.

4. The roller bearing cage according to claim 2, further comprising:
a fixing structure which fixes the bar-shaped member and the connecting member so as to be relatively unrotatably around an axis line along the lengthwise direction of the bar-shaped member.

5. The roller bearing cage according to claim 4,
wherein the fixing structure comprises:
a male screw portion formed in an end portion of the bar-shaped member; and
a female screw member to be screwed on the male screw portion inserted into the hole formed in the connecting member.

6. The roller bearing cage according to claim 4,
wherein the fixing structure comprises:
an end portion of the bar-shaped member; and
a hole formed in the connecting member to which the end portion of the bar-shaped member is press-fitted.

7. The roller bearing cage according to claim 2,
wherein a space surrounded by the bar-shaped members adjacent to each other along the circumferential direction and the connecting member connecting the bar-shaped members is formed as a pocket for holding the rolling element.

8. The roller bearing cage according to claim 2,
wherein the bar-shaped member is inserted into a hole formed on a center axis line of the rolling element.

9. A production method for the roller bearing cage according to claim 2, said production method comprising:
forming, in the connecting member formed in a plate shape, a hole for inserting and attaching the bar-shaped member in a direction perpendicular to the connecting member; and
bending the connecting member after forming the hole.

10. An assembly method for the roller bearing cage according to claim 4, said assembly method comprising:
connecting the plurality of bar-shaped members and the plurality of connecting members so as to form a ring shape in a state in which at least one end portion of the bar-shaped member and the connecting member are placed so as to be relatively rotatably around the axis line, and disposing the connected bar-shaped members and the connecting members along a bearing ring of the roller bearing; and
fixing, by the fixing structure, the bar-shaped members and the connecting members disposed along the bearing ring so as to be relatively unrotatably around the axis line.

11. A roller bearing comprising:
an inner ring;
an outer ring disposed on an outside along a radial direction of the inner ring;
a plurality of rolling elements arranged along a circumferential direction between the inner ring and the outer ring; and
the cage according to claim 2, which retains an interval along the circumferential direction between the plurality of rolling elements.

12. A split cage for a roller bearing, comprising:
a plurality of first segments made of a synthetic resin and a plurality of second segments made of a synthetic resin, the first segments and the second segments being arranged in a ring shape along a circumferential direction,
wherein each of the plurality of first segments comprises:
a rim portion positioned on a first side along an axial direction;
a pair of pillar portions which protrude from the rim portion toward a second side along the axial direction opposite to the first side along the axial direction, and which are respectively disposed between rolling elements of the roller bearing; and
a pair of engaging portions provided on the second side along the axial direction of the pair of pillar portions,
wherein each of the plurality of second segments comprises:
a first engaged portion to be engaged with the engaging portion provided on the pillar portion disposed on a first side along the circumferential direction of the first segment; and
a second engaged portion to be engaged with the engaging portion provided on the pillar portion disposed on a second side along the circumferential direction opposite to the first side along the circumferential direction of another one of the first segments adjacent, on the first side along the circumferential direction, to the first segment, and
wherein the pair of engaging portions are engaged with the pair of engaged portions, whereby the plurality of first segments are connected in a ring shape by the plurality of second segments.

13. The split cage for a roller bearing according to claim 12,
wherein each of the plurality of first segments comprises a contact portion to be brought into contact with another one of the first segments adjacent along the circumferential direction.

14. The split cage for a roller bearing according to claim 12,
wherein each of the plurality of second segments comprises a contact portion to be brought into contact with another one of the second segments adjacent along the circumferential direction.

15. The split cage for a roller bearing according to claim 12,
wherein a surface of the pillar portion to be in contact with a roller used as the rolling element has a bent surface recessed along the circumferential direction for restraining the roller from moving along a radial direction.

16. The split cage for a roller bearing according to claim 12,
wherein the engaged portion has a recess through which the engaging portion is capable of being inserted from the radial direction and from which the inserted engaging portion is incapable of being pulled out along the axial direction,
wherein each of the plurality of second segments has a groove, which is opened on a surface on the first side along the axial direction of the second segment and crosses the engaged portions, and
wherein said split cage for a roller bearing further comprises a stopper which is inserted in the groove and which prevents the engaging portion engaged with the engaged portion from coming off in the radial direction.

17. The split cage for a roller bearing according to claim 12,
wherein each of the engaged portions has a recess through which the engaging portion is capable of being inserted from outside along the radial direction and from which the inserted engaging portion is incapable of being pulled out in the axial direction, and
wherein said split cage for a roller bearing further comprises a projection which is formed in an outer side along the radial direction of each of the plurality of second segments which prevents the engaging portion engaged with the engaged portion from coming off outward in the radial direction.

18. The roller bearing cage according to claim 1,
wherein the fixing structure comprises:
a male screw portion formed in an end portion of the bar-shaped member; and
a female screw member to be screwed on the male screw portion inserted into the hole formed in the connecting member.

19. The roller bearing cage according to claim 1,
wherein the fixing structure comprises:
an end portion of the bar-shaped member; and
a hole formed in the connecting member to which the end portion of the bar-shaped member is press-fitted.

20. The roller bearing cage according to claim 1,
wherein a space surrounded by the bar-shaped members adjacent to each other along the circumferential direction and the connecting member connecting the bar-shaped members is formed as a pocket for holding the rolling element.

21. The roller bearing cage according claim 1,
wherein the bar-shaped member is inserted into a hole formed on a center axis line of the rolling element.

22. An assembly method for the roller bearing cage according to claim 1, said assembly method comprising:
connecting the plurality of bar-shaped members and the plurality of connecting members so as to form a ring shape in a state in which at least one end portion of the bar-shaped member and the connecting member are placed so as to be relatively rotatably around the axis line, and disposing the connected bar-shaped members and the connecting members along a bearing ring of the roller bearing; and
fixing, by the fixing structure, the bar-shaped members and the connecting members disposed along the bearing ring so as to be relatively unrotatably around the axis line.

23. A roller bearing comprising:
an inner ring;
an outer ring disposed on an outside along a radial direction of the inner ring;
a plurality of rolling elements arranged along a circumferential direction between the inner ring and the outer ring; and
the cage according to claim 1, which retains an interval along the circumferential direction between the plurality of rolling elements.
